(19) United States
(12) Patent Application Publication
(10) Pub. No.: US 2011/0269560 A1
(43) Pub. Date: Nov. 3, 2011

(54) SYSTEM AND ARTICLE FOR ADVERTISING

(76) Inventors: Regan Soper, Christchurch (NZ); Murray George William Taylor, North Canterbury (NZ)

(21) Appl. No.: 13/129,214

(22) PCT Filed: Nov. 12, 2009
(86) PCT No.: PCT/NZ09/00243

§ 371 Date: Jul. 19, 2011

(30) Foreign Application Priority Data
Nov. 13, 2008 (NZ) 572784

(51) Int. Cl. A63B 57/00; G09F 23/02

(52) U.S. Cl. 473/175; 283/56; 283/67

(57) ABSTRACT

An insert for a golf cup which includes: a base having a central hole and one or more drainage apertures; a cylindrical wall; wherein the insert has a shape which substantially corresponds to the internal region of the cup in which the insert fits the insert characterised in that the base and wall both include indicia thereon.

### STATEMENT OF CORRESPONDING APPLICATIONS

This application is based on the Complete Specification filed in relation to New Zealand Patent Application Number 572784, the entire contents of which are incorporated herein by reference.

### TECHNICAL FIELD

The present invention relates to a system and article for advertising.

### BACKGROUND ART

In particular the present invention relates to a system for advertising on sporting articles. However it should be appreciated that the system could well be applied to advertising on articles used in other situations without departing from the scope of the present invention.

For ease of reference only the present invention will be initially described in relation to a system for advertising on sporting articles.

In particular the system provides:
a new way that sporting and other organisations/companies can obtain advertising income without requiring additional capital expenditure;
a new way for sporting goods manufacturers to obtain increased advertising exposure of their brand;
a new way sporting goods manufacturers can obtain income from advertising;
a new way third parties can advertise alongside a well known (or an up and coming brand) in the sport and get the benefits of positive brand association.

The community also benefits as the additional advertising income can help secure the future of the sporting organisation.

The present invention for ease of reference only will now be described in relation to advertising on a golf course owned, leased or otherwise occupied by a golf club. However, it should be appreciated that this is just but one application to which the system and article of the present invention are suited. The following discussion should therefore not be seen as limiting the scope of the present invention.

Golf courses are typically run by golf clubs which generally rely on revenue generated from the following sources:
membership fees;
green fees;
traditional advertising including: sponsor(s) advertising at holes and in the club house;
   to maintain the course and clubhouse facilities. Golf courses would therefore benefit if they could have additional revenue streams especially those which did not require any further capital outlay on their part.

Sporting goods manufacturers and other advertisers are keen to target golfers as they generally represent a high earning demographic. It would therefore be useful if there could be provided a system which could increase brand exposure of a sporting goods manufacturer (SGM) or other advertiser interested in targeting golfers.

Traditional advertising for sporting goods manufacturers of golf equipment is generally limited to golf bags, golf balls, clothing and golf clubs being used by an individual; or to advertising in the pro-shop or perhaps at the clubhouse.

However, it would be useful if the brand of a SGM or other advertiser could be more pervasively placed around a golf course especially in a region which regularly has every golfer's attention.

Previously a number of golf cup inserts, or golf cups themselves, have been devised for advertising in the cups of a golf course see for example U.S. Pat. No. 4,928,417, US 2004/0092325, U.S. Pat. No. 6,712,714 and U.S. Pat. No. 5,362,044 as exemplary examples of the prior art devices. However, these devices only display advertisements either: on the base of the cup/insert, or in one case U.S. Pat. No. 5,362,044, on the walls of the insert. This limitation as to the areas on which advertisement are displayed is to be expected as there has, up until the system of the present invention, been no compelling reason as to why advertisements would need to be displayed in two remote positions. The fact that none of the known devices have been widely used on golf courses suggests that golf clubs having to pay for the devices to be installed on their course is a significant deterrent to their uptake and thus their commercial viability.

It would also be useful if there could be provided an article for advertising (article) which could be used to clearly display the brand of a SGM or other primary advertiser and at least one additional advertiser in the holes of a golf course.

It would also be useful if there could be provided an article which displays two advertisements in at least two distinct locations.

It would also be useful if there could be provided an article which can be used in a cup of a golf hole which does not affect the dimensions of a hole from either a golfer's perspective or in terms of the Royal and Ancient Rules of golf.

It would also useful if there could be provided an article which can be secured into a cup of a golf hole.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

An advertising system characterised in that the system includes:
an article on which a primary advertiser (PA) of the article advertises together with at least one additional advertiser (AA);
   the system further characterised in that a user makes use of the article and exposes the article to a captive audience wherein the system provides a shared income to the both PA and user which is derived from the AA paying to advertise on the article.

An advertising system characterised in that the system includes:
an article for insertion into a golf hole on which an PA advertises together with at least one additional advertiser (AA);
   the system further characterised in that a user in the form of a golf club makes use of the article in holes of the user's golf course and exposes the product to a captive market in the form of golfers playing the course wherein the system provides a shared income to the both the PA and user which is derived from the AA paying to advertise on the article.

As used here in the term ‘article’ covers any device or apparatus on which one may want to advertise in accordance with the system of the present invention.

In one preferred embodiment the article may be an insert for a golf cup.

The terms ‘advertises’ and ‘advertisement’ (and grammatical variants thereof) as used herein generally refers to the display of indicia distinctive to an PA or AA. In general the indicia may be brand(s) including but not limited to images, words, shapes, smells, slogans or other identifiers.

The term ‘primary advertiser’ or PA as used herein refers to a business or organisation which owns, supplies or produces the article on which it advertises together with the AA.

The term ‘additional advertiser’ or ‘AA’ as used herein generally refers to a business or organisation which wants to advertise to the captive market of the user. In some cases there may be more than one AA however for ease of reference only this term will be referred to in the singular form.

The term ‘user’ generally refers to a business or organisation which makes use of the article on which the first and second parties advertise.

In preferred embodiments the PA, AA and user are all separate entities. Most preferably the entities are unrelated to one another.

In one particularly preferred embodiment the PA may be a sporting goods manufacturer (SGM). Most preferably the SGM may manufacture golf equipment.

In one particularly preferred embodiment the AA may be an advertiser who already has an advertising or sponsorship arrangement with the user. Most preferably the AA may be the major sponsor of a golf club.

The term “captive audience” as used herein refers to a group of people who have no choice other than to be visually subjected to advertising which is placed on an object which will require their specific attention at least some point but preferably on multiple occasions.

The term “shared income” as used herein refers to an income stream which is divided between at least two parties. In general the income may be monetary or have monetary value. The income may be shared equally or otherwise divided according to an agreement reached between the PA and the user.

According to one aspect of the present invention there is provided an article in the form of a placement device for a golf hole wherein the device includes indicia of an PA together with the indicia of an AA both positioned so as to be visible, in use, by a golfer standing above or near the hole.

The placement device may come in a variety of different forms without departing from the scope of the present invention.

In one embodiment the placement device may be in the form a flag on a pole adapted to be inserted in the form of a golf cup in the hole of a putting green.

In the flag embodiments the flag may be configured to have two distinct areas on which two separate parties can clearly display their separate advertisements.

The flag may preferably display the advertisement of the PA and the pole may display the advertisement of the AA.

In preferred embodiments of the present invention the placement device may be in the form of an insert configured to be inserted into a cup of a golf hole and to have at least two distinct areas on which two separate parties can clearly display their separate advertisements.

According to another aspect of the present invention there is provided an insert for a golf cup which includes:
a base having a central hole and one or more drainage apertures;
a cylindrical wall;
   wherein the insert has a shape which substantially corresponds to the internal region of the cup in which the insert fits the insert characterised in that the base and wall both include indicia thereon.

According to a yet further aspect of the present invention there is provided an insert substantially as described above wherein the indicia on the base is that of a PA and the indicia on the wall is that of an AA.

According to a still further aspect of the present invention there is provided an insert substantially as described above wherein the indicia are imprinted or otherwise displayed on the base and wall. Preferably, the indicia may be applied to the insert so as to be substantially non-removable.

According to another aspect of the present invention there is provided an insert substantially as described above wherein the cylindrical wall does not extend from the base more than substantially 50% of the height of the cup into which the insert is to be placed.

According to a further aspect of the present invention there is provided an insert substantially as described above wherein the cylindrical wall does not extend more than substantially 30 mm above the base.

According to a yet further of the present invention there is provided an insert substantially as described above wherein the top lip of the cylindrical wall is sloped downwardly from the outside edge of the wall to the inner edge of the wall.

According to a still further aspect of the present invention there is provided an insert substantially as described above wherein at least a portion of the cylindrical wall's outer surface is adapted to help grip the inside of the cup.

In preferred embodiments the outer wall may include contours thereon which increase the frictional resistance between the respective surfaces of the insert and the cup.

According to a still further aspect of the present invention there is provided an insert substantially as described above wherein the insert has one or more locating protrusions extending into the drainage holes of a cup. Preferably the protrusions may be an extension of the drainage apertures in the insert.

The insert is preferably made from a durable water proof UV resistant material capable of bearing indicia.

In preferred embodiments the insert is made from acrylic.

In preferred embodiments the wall(s) of the insert are preferably substantially 1 mm thick.

The indicia may be placed or imprinted on the insert in a variety of different ways without departing from the scope of the present invention.

In preferred embodiments the indicia may be applied to the outside surfaces of the base and wall of the insert so as to be protected from damage occurring from the ball dropping in the hole when a player sinks a putt.

Preferably the central hole of the insert may have dimensions which are larger than those of the end of the flag pole which is retained by the cup.

According to another aspect of the present invention there is provided an article for use in a sporting activity wherein the article includes indicia of an PA together with the indicia of an AA both positioned so as to be clearly visible, in use, by a player engaged in the sporting activity.

According to a still further aspect of the present invention there is provided an advertising system for use on an insert characterised in that the system includes:
an insert on which a primary advertiser (PA) advertises together with at least one additional advertiser (AA);
   the system further characterised in that a user in the form of a golf club makes use of the insert in golf holes to expose the insert to a captive audience in the form of golfers wherein the system provides a shared income to the both PA and golf club which is derived from the AA paying to advertise on the insert.

According to a further aspect of the present invention there is provided a method of using an article substantially as described above wherein the article is used by a user who organises, runs, or hosts a sporting activity.

According to a still further aspect of the present invention there is provided a method substantially as described above wherein the user derives income from the advertising.

According to another aspect of the present invention there is provided a method substantially as described above wherein the user is not owned or controlled (whether wholly or partially) by either the PA or AA.

Thus preferred embodiments of the present invention may have a number of advantages over the prior art which can include, but should not be limited to:
A system for increasing advertising exposure for an PA and generating revenue for the PA and a user from an AA paying to advertise alongside the PA.
An article which facilitates the system of the present invention.
An article which can be used on a golf course.
A system and article which can increase the advertising exposure of a sporting goods manufacturer and local golf club sponsor.
A system which generates additional revenue for a golf club with no additional capital expenditure being required.

Further advantages are discussed throughout this specification or otherwise will be apparent to a skilled reader.

### BRIEF DESCRIPTION OF DRAWINGS

Further aspects of the present invention will become apparent from the following description which is given by way of example only and with reference to the accompanying drawings in which:

FIG. 1 is a top perspective view of a golf hole illustrating one preferred embodiment of the present invention where the article is in the form of an insert;

FIG. 2a is a plan view of the insert shown in FIG. 1;

FIG. 2b is a side view of the insert shown in FIG. 1;

FIG. 3 is a side view of a flag assembly in accordance with a further embodiment of the present invention.

### BEST MODES FOR CARRYING OUT THE INVENTION

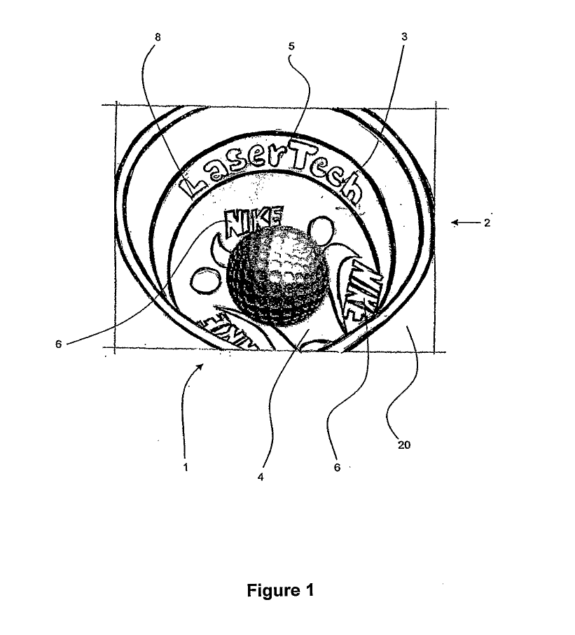

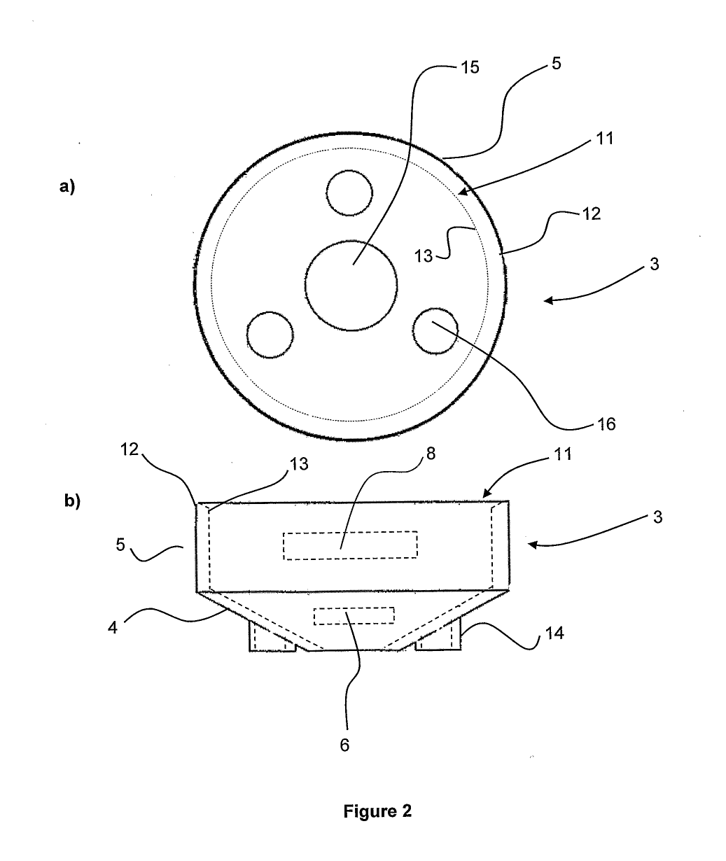

With respect to FIGS. 1 and 2 there is provided a hole 1 in a putting green 20. The hole 1 has a cup 2 therein and fitted within the cup 2 is an article in the form of an insert 3. The insert 3 has a base 4 and a cylindrical wall 5.

The insert 3 has advertising in the form of indicia 6 of an PA on the outside surface 7 of the base 4 and advertising in the form of indicia 8 of an AA on the outside surface 9 of the wall 5.

In FIG. 1 a golf ball 10 is shown in the hole 1 to illustrate how visible the advertising 6 and 8 is to a player retrieving their ball 10 from the hole 1.

In FIG. 2a it can be seen that the insert 3 has a central aperture 15 for receiving a flag and drainage apertures (drains) 16. FIG. 2b it can be seen that top lip 11 of wall 5 is sloped downwardly from outside edge 12 of the wall to the inner edge 13 of the wall 5. The insert 3 also has hollow drainage projections 14 which are extensions of the drains 16 and which fit into the drainage holes of a cup (not shown). The outside dimensions of the insert closely correspond to those of inner surface of the cup in which the inserts sits after being slid therein. The inventor has found this creates a frictional and/or vacuum like engagement of the insert to the cup which can help prevent accidental or malicious removal of the insert.

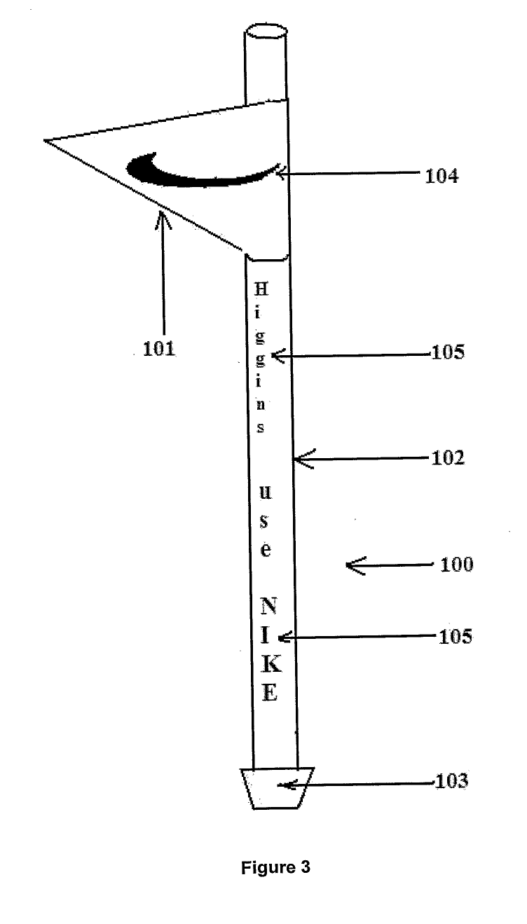

In FIG. 3 there is provided a flag assembly 100 consisting of a flag 101 and a flag pole 102 which has a base 103 which locates in a central hole of a golf cup (not shown). The flag 101 has advertising in the form of indicia 104 of an PA and the flag pole 102 has advertising in the form of indicia 105 of an AA.

Aspects of the present invention have been described by way of example only and it should be appreciated that modifications and additions may be made thereto without departing from the scope thereof as defined in the appended claims.

What we claim is:

1. An insert for a golf cup which includes:
a base having a central hole and one or more drainage apertures;
a cylindrical wall;
wherein the insert has a shape which substantially corresponds to the internal region of the cup in which the insert fits the insert characterised in that the base and wall both include indicia thereon.

2. An advertising system characterised in that the system includes:
an insert as claimed in claim 1 for insertion into a golf hole on which a primary advertiser (PA) advertises together with at least one additional advertiser (AA);
the system further characterised in that a user in the form of a golf club makes use of the article in holes of the user's golf course and exposes the product to a captive market in the form of golfers playing the course wherein the system provides a shared income to the both the PA and user which is derived from the AA paying to advertise on the article.

3. An insert for a golf cup which includes:
a base having a central hole and one or more drainage apertures;
a cylindrical wall;
wherein the insert has a shape which substantially corresponds to the internal region of the cup in which the insert fits the insert characterised in that the base and wall both include indicia thereon.

4. An insert as claimed in claim 1 wherein the indicia on the base is that of a PA and the indicia on the wall is that of an AA.

5. An insert as claimed in any one of the preceding claims wherein the indicia are imprinted or otherwise displayed on the base and wall.

6. An insert as claimed in any one of the preceding claims wherein the cylindrical wall does not extend from the base more than substantially 50% of the height of the cup into which the insert is to be placed.

7. An insert as claimed in any one of the preceding claims wherein the cylindrical wall does not extend more than substantially 30 mm above the base.

8. An insert as claimed in any one of the preceding claims wherein the top lip of the cylindrical wall is sloped downwardly from the outside edge of the wall to the inner edge of the wall.

9. An insert as claimed in any one of the preceding claims wherein at least a portion of the cylindrical wall's outer surface is adapted to help grip the cup.

10. An insert as claimed in any one of the preceding claims wherein the insert has one or more locating protrusions extending into the drainage holes of a cup.

11. An article for use in a sporting activity wherein the article includes indicia of an PA together with the indicia of an AA both positioned so as to be clearly visible, in use, by a player engaged in the sporting activity.

12. An advertising system for use on an insert as claimed in claim 1 characterised in that the system includes:
an insert on which a primary advertiser (PA) advertises together with at least one additional advertiser (AA);
the system further characterised in that a user in the form of a golf club makes use of the insert in golf holes to expose the insert to a captive audience in the form of golfers wherein the system provides a shared income to the both PA and golf club which is derived from the AA paying to advertise on the insert.

13. A method of using an article as claimed in claim 11 wherein the article is used by a user who organises, runs, or hosts a sporting activity.

14. A method as claimed in claim 13 wherein the user derives income from the advertising.

15. A method as claimed in either claim 13 or 14 wherein the user is not owned or controlled (whether wholly or partially) by either the PA or AA.

16. An advertising system characterised in that the system includes:
an article on which a primary advertiser (PA) of the article advertises together with at least one additional advertiser (AA);
the system further characterised in that a user makes use of the article and exposes the article to a captive audience wherein the system provides a shared income to the both PA and user which is derived from the AA paying to advertise on the article.
